(19) United States
(12) Patent Application Publication
(10) Pub. No.: US 2026/0284805 A1
(43) Pub. Date: Sep. 24, 2026

(54) WELDING POSITIONER APPARATUS

(71) Applicant: BRILS Co., Ltd., Incheon (KR)

(72) Inventors: Won Jai CHOI, Incheon (KR); Se Chun KI, Cheongju-si Chungcheongbuk-do (KR); Jin JEON, Incheon (KR)

(73) Assignee: BRILS Co., Ltd., Incheon (KR)

(21) Appl. No.: 19/561,871

(22) Filed: Mar. 10, 2026

(30) Foreign Application Priority Data
Mar. 21, 2025 (KR) 10-2025-0036668

(51) Int. Cl. B23K 37/04; B23K 101/00

(52) U.S. Cl. CPC B23K 37/0452; B23K 37/0435; B23K 2101/006

(57) ABSTRACT

A welding positioner apparatus includes a support stage on which a welding object is seated; a multi-axis motion assembly configured to rotatably support the support stage about at least a first rotation axis and a second rotation axis perpendicular to the first rotation axis to enable multi-axis motion control of at least two axes with respect to the support stage; a clamp module pivotally installed at both ends of a seating portion of the support stage to clamp the welding object seated on the support stage, the clamp module configured to selectively press at least a portion of a lower frame of the welding object; and a controller configured to control the multi-axis motion of the multi-axis motion assembly such that a welding portion of the welding object is positioned within an operation range of a welder during welding of the welding object.

### CROSS-REFERENCE TO RELATED PATENT APPLICATION

This application claims the benefit under 35 U.S.C. § 119 of Korean Patent Application No. 10-2025-0036668, filed on March 21, 2025, the disclosure of which is hereby incorporated by reference in its entirety.

### BACKGROUND OF THE INVENTION

### 1. Field of the Invention

The present disclosure relates to a welding positioner apparatus, and more particularly, to a welding positioner apparatus capable of producing a cabin of heavy construction equipment by automated multi-axis welding.

### 2. Description of Related Art

Heavy construction equipment used for civil engineering and construction work is an essential element for construction work such as civil engineering and building construction for human residence. With the trend toward larger scale, higher, deeper depth, and automation of construction work, the proportion of heavy construction equipment is expected to increase day by day. That is, heavy construction equipment is a key element for successful construction work, and its importance will be further highlighted in order to perform efficient work with a small number of personnel in the current situation where it is difficult to secure labor.

Representative heavy construction equipment includes excavators, dump trucks, concrete mixer trucks, concrete pump cars, cranes, forklifts, etc., and there are working vehicles for construction machinery specially designed to perform various tasks (aerial ladder, crane, forklift work, harvesting of paddy/field crops, excavation work) based on a traveling apparatus.

Here, attachments necessary for various construction works may be mounted on the heavy construction equipment. For example, it refers to various modules such as a bucket, a breaker, a drill, a grab, etc., attached thereto including a device such as a boom or an arm of an excavator.

In addition, a driver's cabin (cockpit) equipped with a controller (manipulator) necessary for the operation of the above-described attachment is installed in the heavy construction equipment, and various construction works such as tunnel and underground space construction excavation work, sand and gravel extraction, crushing and demolition work, etc., can be performed by the operation of the attachment according to the operation of the controller.

The cabin of such heavy construction equipment may be manufactured by forming a thin plate into an inner plate and an outer plate of a necessary shape by press forming and joining the formed inner plate and outer plate by welding, thereby implementing an appearance including a front surface and an upper surface of the cabin in various curved shapes.

However, since the cabin of such conventional heavy construction equipment is manufactured by a worker performing a welding operation manually, the manufacturing process takes too much time, and there is a high possibility of injury to the worker during the manual welding process while moving the position of the cabin, which is a heavy structure, to change the welding posture. In addition, existing manual welding leads to potential inconsistent welding quality, lowering the efficiency of the overall cabin manufacturing process and increasing the possibility of defects.

### SUMMARY OF THE INVENTION

The present disclosure is intended to solve various problems including the above problems, and an object of the present disclosure is to provide a welding positioner apparatus capable of producing a cabin of heavy construction equipment by automated multi-axis welding by performing multi-axis motion control of at least two axes or more with respect to a seated welding object. However, these objects are exemplary and do not limit the scope of the present disclosure.

According to an embodiment of the present disclosure, a welding positioner apparatus is provided. The welding positioner apparatus may include: a support stage on which a welding object is seated; a multi-axis motion assembly configured to rotatably support the support stage about at least a first rotation axis and a second rotation axis perpendicular to the first rotation axis so that multi-axis motion control of at least two axes is possible with respect to the support stage; a clamp module pivotally installed at opposite ends of a seating portion of the support stage on which the welding object is seated so as to clamp the welding object seated on the support stage, the clamp module configured to selectively press at least a portion of a lower frame of the welding object; and a controller configured to control multi-axis motion of the multi-axis motion assembly so that a welding portion of the welding object is located within an operation range of a welder for welding the welding object during welding of the welding object.

According to an embodiment of the present disclosure, the multi-axis motion assembly may include: a body frame; a first motion module installed at one end of the body frame to support the support stage and rotate the support stage about the first rotation axis; and a second motion module installed at the other end of the body frame to support the body frame and rotate the body frame about the second rotation axis

According to an embodiment of the present disclosure, the first motion module may include: a first motion body installed to be in contact with both inner side walls of the body frame so as to be located inside the body frame at the one end of the body frame formed in an overall 'H' shape; a rotation plate rotatably installed on an upper side of the first motion body about the first rotation axis to support the support stage; and a first motion motor installed on a lower side of the first motion body to rotationally drive the rotation plate.

According to an embodiment of the present disclosure, the first motion body may be installed to be rotatable about a third rotation axis parallel to the second rotation axis at the one end of the body frame.

According to an embodiment of the present disclosure, the multi-axis motion assembly may further include a third motion module configured to rotationally drive the first motion body by a third motion motor installed to be in contact with an outer side wall of the body frame at the one end of the body frame.

According to an embodiment of the present disclosure, the second motion module may include: a second motion body installed to be in contact with both outer side walls of the body frame at the other end of the body frame formed in an overall 'H' shape to support the body frame in a cantilever form as a hinge part and rotatably support the body frame about the second rotation axis; and a second motion motor installed at one side of the second motion body to rotationally drive the body frame.

According to an embodiment of the present disclosure, the second motion module may further include a support cylinder formed to have a variable length so as to support the one end of the body frame supported in the cantilever form by the second motion body or assist rotational driving of the body frame by the second motion motor, the support cylinder connecting a lower end of the second motion body and the one end of the body frame.

According to an embodiment of the present disclosure, the multi-axis motion assembly may further include a fourth motion module configured to slidingly move the second motion module along a linear axis perpendicular to the second rotation axis.

According to an embodiment of the present disclosure, the fourth motion module may include: a fourth motion body formed to extend in a rectangular parallelepiped shape long along the linear axis; a plurality of guide rails formed to extend in a rail shape long along the linear axis and installed on an upper side of the fourth motion body; a sliding stage installed to be slidingly movable along the plurality of guide rails on the upper side of the fourth motion body and supporting the second motion body; and a sliding drive assembly installed at the fourth motion body to slidingly drive the sliding stage.

According to an embodiment of the present disclosure, the sliding drive assembly may include: a ball screw formed to extend in a rod shape long along the linear axis and rotatably installed on the upper side of the fourth motion body; a movable nut coupled to a lower side of the sliding stage and screw-coupled to the ball screw, the movable nut installed to be slidingly movable together with the sliding stage in an extension direction of the ball screw according to rotational driving of the ball screw; and a fourth motion motor installed at one side of the fourth motion body to rotationally drive the ball screw.

According to an embodiment of the present disclosure, the clamp module may include: a clamp hinge installed at one end of the seating portion of the support stage; a clamp body rotatably installed at the clamp hinge to selectively press at least a portion of the lower frame of the welding object during descending rotation; a rotation cylinder installed on the seating portion of the support stage and formed to have a variable length to rotate the clamp body; and a two-bar linkage connecting the rotation cylinder and the clamp body so as to convert linear motion of the rotation cylinder into rotational motion of the clamp body.

According to an embodiment of the present disclosure, the support stage may include: a stage body formed in an overall rectangular plate shape so that the seating portion on which the welding object is seated is formed; and a seating guide assembly installed at a support bracket formed to protrude from a corner portion of the stage body, the seating guide assembly configured to guide and support a seating position of the welding object seated on the stage body by a support bushing formed to protrude to an upper side of the support bracket and a support pin formed to protrude to an upper side of the support bushing.

According to an embodiment of the present disclosure constructed as described above, the support stage on which the welding object is seated is supported to be automatically rotatable and slidingly movable in at least two or more axes by the multi-axis motion assembly, so that even if a welding portion changes during welding of the welding object, the changed welding portion can be located within an operation range of a multi-axis automatic welder for welding the welding object, thereby facilitating a change in a welding posture of the welding object and inducing welding work to be performed uniformly.

As such, by automating the welding work of a welding object having a heavy weight such as a cabin of heavy construction equipment by automated multi-axis welding, it is possible to reduce the possibility of injury to a worker that may occur during the welding posture change of the cabin which is a heavy structure, improve the quality of welding by welding in a constant welding posture, and implement a welding positioner apparatus capable of increasing the efficiency of the cabin manufacturing process of heavy construction equipment. Of course, the scope of the present disclosure is not limited by these effects.

### BRIEF DESCRIPTION OF THE DRAWINGS

FIG. 1 is a perspective view schematically showing a welding positioner apparatus according to an embodiment of the present disclosure.

FIG. 2 is a cross-sectional view schematically showing the welding positioner apparatus of FIG. 1.

FIG. 3 is an enlarged view showing an enlarged state of portion "A" of FIG. 1.

FIG. 4 is an enlarged view showing an enlarged state of portion "B" of FIG. 2.

FIGS. 5 and 6 are partial perspective views schematically showing a state in which a welding object is seated and supported on a support stage of the welding positioner apparatus of FIG. 1.

FIGS. 7 and 8 are perspective views schematically showing a multi-axis motion assembly of the welding positioner apparatus of FIG. 1.

### DETAILED DESCRIPTION OF THE INVENTION

Hereinafter, various preferred embodiments of the present disclosure will be described in detail with reference to the accompanying drawings.

Embodiments of the present disclosure are provided to more completely explain the present disclosure to those skilled in the art, and the following embodiments may be modified into various other forms, and the scope of the present disclosure is not limited to the following embodiments. Rather, these embodiments are provided to make this disclosure more faithful and complete, and to fully convey the spirit of the present disclosure to those skilled in the art. In addition, the thickness or size of each layer in the drawings is exaggerated for convenience and clarity of explanation.

Hereinafter, embodiments of the present disclosure will be described with reference to the drawings schematically showing ideal embodiments of the present disclosure. In the drawings, for example, variations of the illustrated shapes may be expected according to manufacturing technology and/or tolerances. Therefore, embodiments of the spirit of the present disclosure should not be construed as being limited to the specific shapes of the regions shown herein, but should include, for example, changes in shapes resulting from manufacturing.

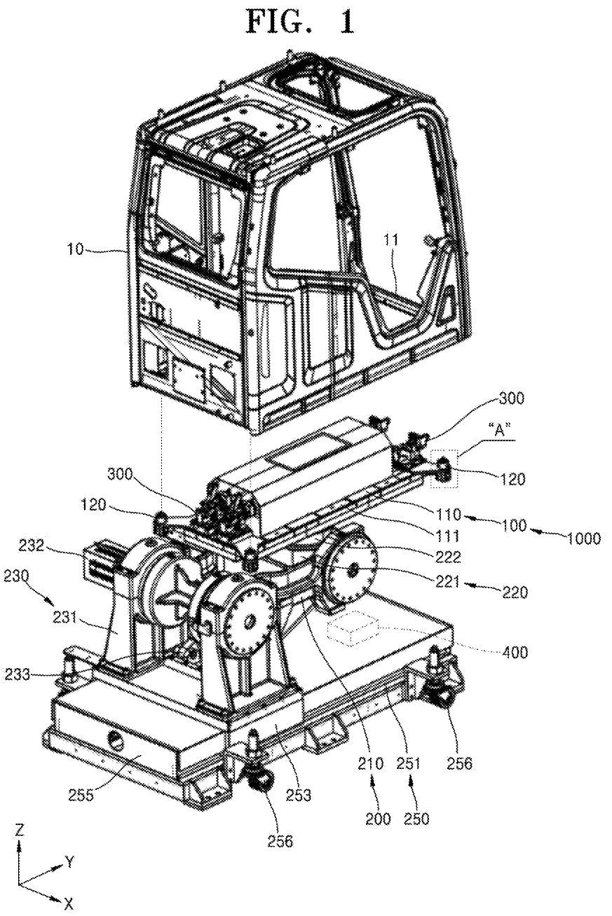

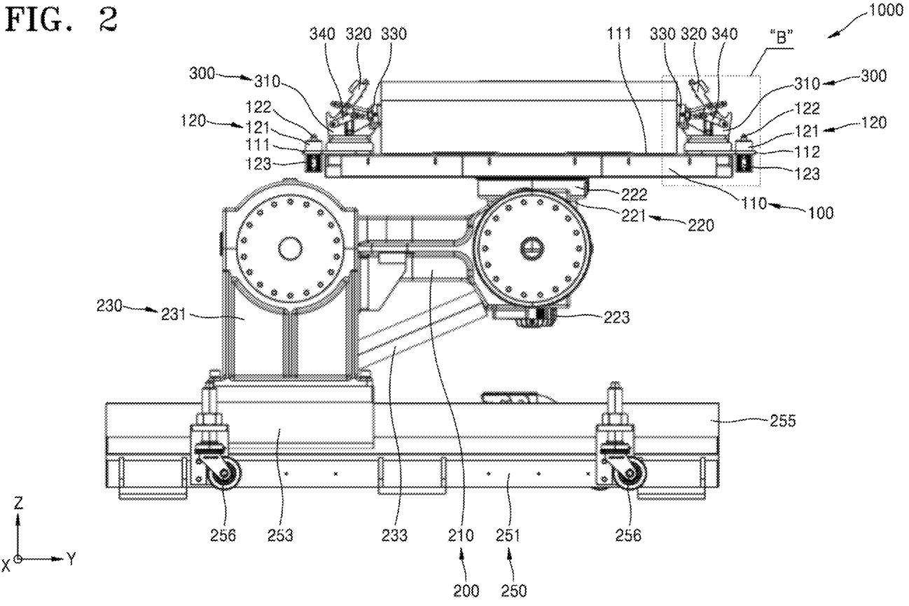

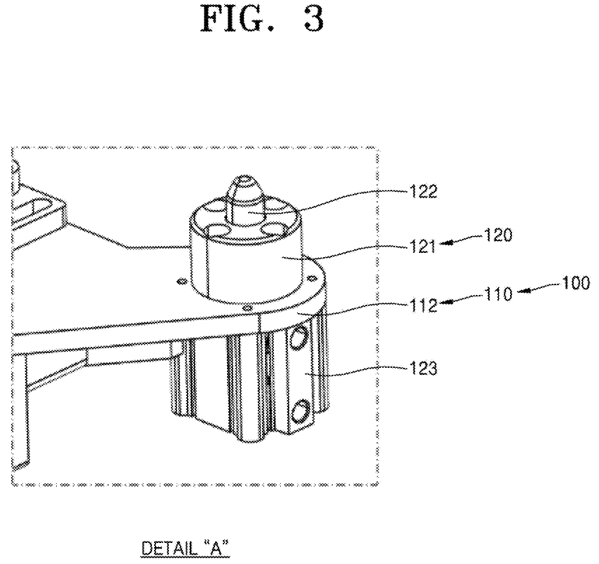

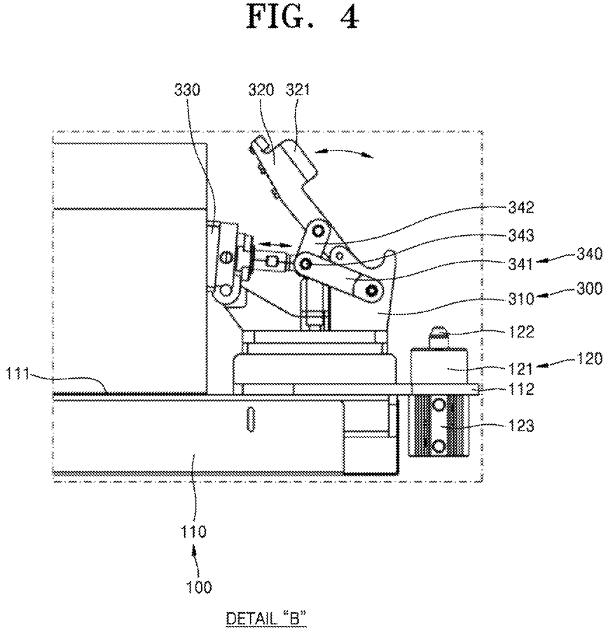

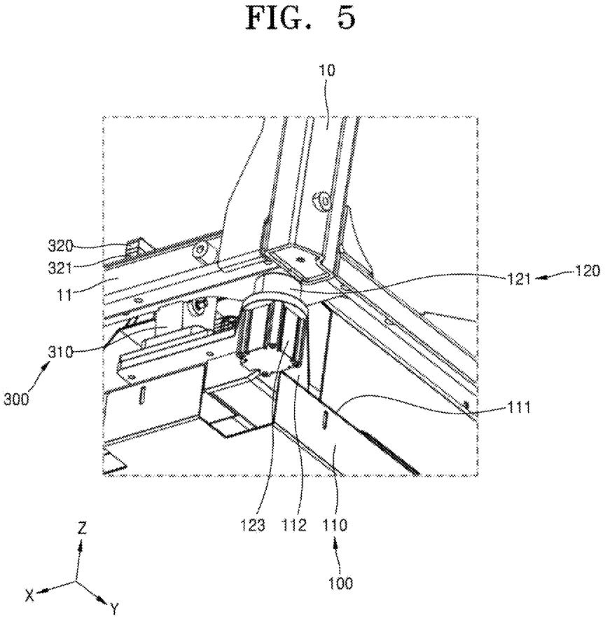

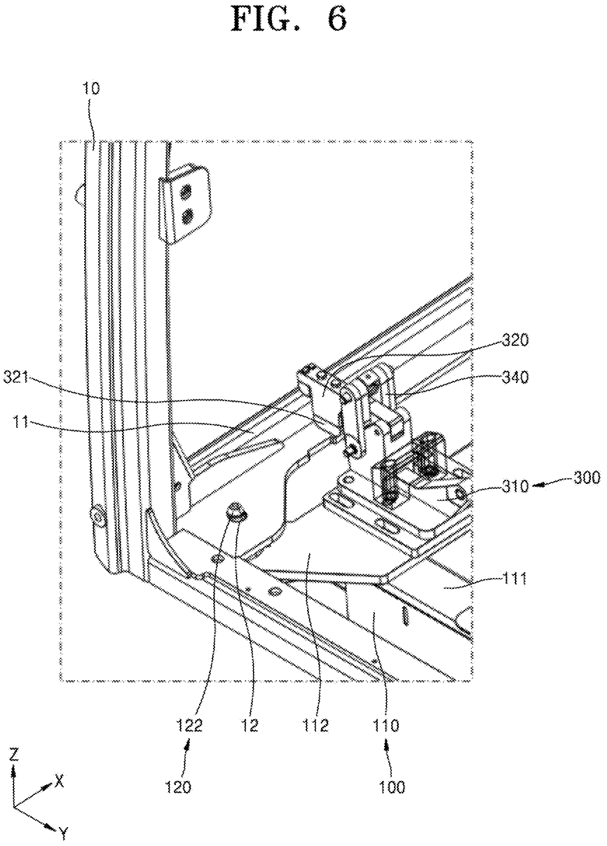

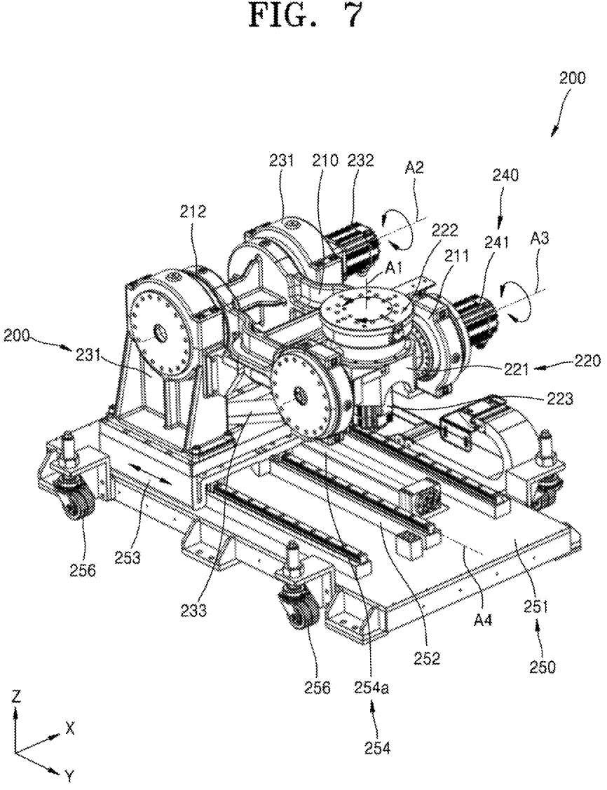

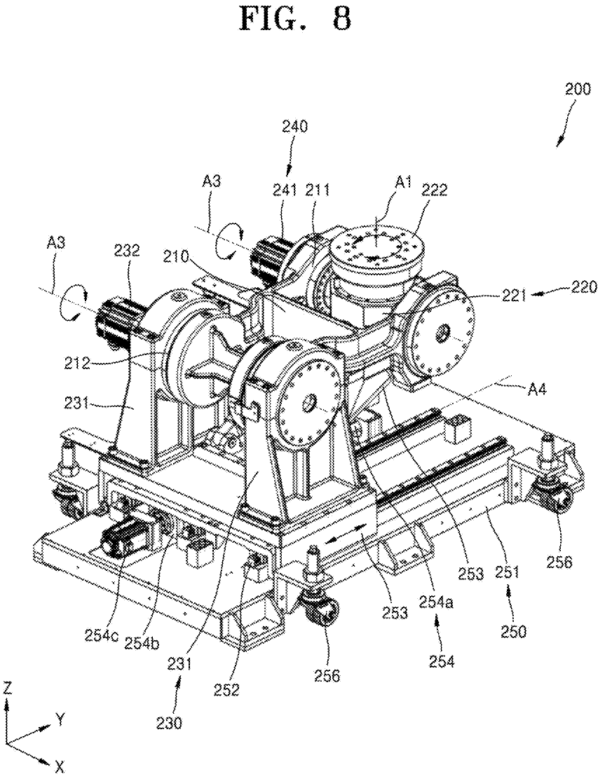

FIG. 1 is a perspective view schematically showing a welding positioner apparatus 1000 according to an embodiment of the present disclosure, FIG. 2 is a cross-sectional view schematically showing the welding positioner apparatus 1000 of FIG. 1, FIG. 3 is an enlarged view showing an enlarged state of portion "A" of FIG. 1, and FIG. 4 is an enlarged view showing an enlarged state of portion "B" of FIG. 2. In addition, FIGS. 5 and 6 are partial perspective views schematically showing a state in which a welding object 10 is seated and supported on a support stage 100 of the welding positioner apparatus 1000 of FIG. 1, and FIGS. 7 and 8 are perspective views schematically showing a multi-axis motion assembly 200 of the welding positioner apparatus 1000 of FIG. 1.

First, as shown in FIGS. 1 and 2, the welding positioner apparatus 1000 according to an embodiment of the present disclosure may largely include a support stage 100, a multi-axis motion assembly 200, a clamp module 300, and a controller 400.

As shown in FIGS. 1 and 2, a welding object 10 may be seated on the support stage 100.

For example, the support stage 100 may include a stage body 110 formed in an overall rectangular plate shape so that a seating portion 111 on which the welding object 10 is seated may be formed, and a seating guide assembly 120 installed at four corner portions of the stage body 110 formed in a rectangular plate shape to guide and support a seating position of the welding object 10 seated on the stage body 110.

More specifically, as shown in FIGS. 1 to 4, the stage body 110 formed in a rectangular plate shape may be provided with support brackets 112 formed to protrude in a diagonal direction (a direction from the center of the stage body toward the corner portion) at the four corner portions.

In addition, the seating guide assembly 120 may include a support bushing 121 formed in an overall cylindrical shape to protrude to an upper side of the support bracket 112, and a support pin 122 formed to protrude to an upper side of the support bushing 121.

As shown in FIGS. 5 and 6, the support bushing 121 is a structure supporting a lower frame 11 of the welding object 10, and is illustrated as being formed in an overall cylindrical shape, but is not necessarily limited thereto, and may be formed in any pillar shape capable of supporting the lower frame 11 of the welding object 10, such as a rectangular pillar shape or a polygonal pillar shape.

As shown in FIGS. 5 and 6, the support pin 122 is a structure inserted into a through-hole portion 12 formed in the lower frame 11 of the welding object 10 so as to guide a seating correct position of the welding object 10, and is formed in an overall cylindrical shape, but it may be preferable that at least a portion of an upper end portion is formed in a conical shape so as to facilitate insertion into the through-hole portion 12 and guide the seating correct position.

In addition, the support pin 122 may be installed such that a protruding height from the support bushing 121 can be adjusted by a drive motor 123 installed on a lower side of the support bracket 112. Accordingly, the support pin 122 may be formed to protrude to the upper side of the support bushing 121 only when the welding object 10 is seated and may be selectively inserted into an inside of the support bushing 121 by being driven to descend when the welding object 10 is detached.

As shown in FIGS. 1 and 2, the clamp module 300 may be pivotally installed at both ends of the seating portion 111 of the support stage 100 on which the welding object 10 is seated so as to clamp the welding object 10 seated on the support stage 100, thereby selectively pressing into at least a portion of the lower frame 11 of the welding object 10.

For example, a pair of clamp modules 300 may be installed to face each other at both ends in a longitudinal direction (Y-axis direction) of the support stage 100 so as to be pivotally installed in opposite directions. In addition, although it is illustrated that two clamp modules 300 are disposed along a width direction (X-axis direction) of the support stage 100, the present disclosure is not limited thereto, and it may be possible to be disposed in a very wide variety of numbers depending on the length in the width direction (X-axis direction) of the support stage 100 or the weight and structure of the welding object 10.

As shown in FIG. 4, such a clamp module 300 may include a clamp hinge 310 installed at one end of the seating portion 111 of the support stage 100; a clamp body 320 rotatably installed at the clamp hinge 310 to selectively press at least a portion of the lower frame 11 of the welding object 10 during descending rotation (see FIG. 6); a rotation cylinder 330 installed on the seating portion 111 of the support stage 100 and formed to have a variable length to rotate the clamp body 320; and a two-bar linkage 340 connecting the rotation cylinder 330 and the clamp body 320 so as to convert linear motion of the rotation cylinder 330 into rotational motion of the clamp body 320.

More specifically, the clamp body 320 may include an elastic member 321 formed at a contact portion with the lower frame 11 so that damage due to pressing does not occur to the lower frame 11 when pressing the lower frame 11.

In addition, the two-bar linkage 340 may include a first link 341 having one end rotatably connected to the clamp hinge 310 by a hinged joint, and a second link 342 having one end rotatably connected to the clamp body 320 by a hinged joint and the other end rotatably connected to the other end of the first link 341 by a hinged joint.

In this case, the rotation cylinder 330 may be connected to a rotational node 343 to which the other end of the first link 341 and the other end of the second link 342 of the two-bar linkage 340 are rotatably connected to each other so that the linear motion thereof can be converted into the rotational motion of the clamp body 320.

Accordingly, the welding object 10 may be firmly seated and supported at a correct position on the seating portion 111 of the support stage 100 by the structure of the seating guide assembly 120 and the structure of the clamp module 300 of the support stage 100 described above acting organically.

As shown in FIGS. 1 and 2, the multi-axis motion assembly 200 may support the support stage 100 so that multi-axis motion control of at least two axes or more is possible with respect to the support stage 100.

In addition, the controller 400 is installed inside or outside the welding positioner apparatus 1000 so as to be electrically connected to the multi-axis motion assembly 200, and may control the multi-axis motion of the multi-axis motion assembly 200 so that a welding portion of the welding object 10 may be located within an operation range of a multi-axis automatic welder (not shown) for welding the welding object 10 during welding of the welding object 10.

For example, as shown in FIGS. 7 and 8, the multi-axis motion assembly 200 may support the support stage 100 so as to be rotatable and slidingly movable with respect to a first rotation axis A1, a second rotation axis A2, a third rotation axis A3, and a linear axis A4 so that multi-axis motion control of four axes is possible for the support stage 100.

Such a multi-axis motion assembly 200 may be largely composed of a body frame 210, a first motion module 220, a second motion module 230, a third motion module 240, and a fourth motion module 250.

The body frame 210 may be formed as a kind of frame structure formed in an overall "H" shape.

The first motion module 220 is installed at one end of the body frame 210 to support the support stage 100, and is configured to rotate the support stage 100 about the first rotation axis A1.

For example, the first motion module 220 may include a first motion body 221 installed to be in contact with both inner side walls 211 of the body frame 210 so as to be located inside the body frame 210 at one end of the body frame 210 formed in an overall "H" shape; a rotation plate 222 rotatably installed on an upper side of the first motion body 221 about the first rotation axis A1 to support the support stage 100; and a first motion motor 223 installed on a lower side of the first motion body 221 to rotationally drive the rotation plate 222.

In this case, the first motion body 221 is installed to be in contact with both inner side walls 211 of the body frame 210 by a hinged joint at one end of the body frame 210 and may be installed to be rotatable about the third rotation axis A3 parallel to the second rotation axis A2.

Accordingly, the third motion module 240 may rotationally drive the first motion body 221 by a third motion motor 241 installed to be in contact with an outer side wall 212 of the body frame 210 at one end of the body frame 210.

The second motion module 230 is installed at the other end of the body frame 210 to support the body frame 210, and is configured to rotate the body frame 210 about the second rotation axis A2.

For example, the second motion module 230 may include a second motion body 231 installed to be in contact with both outer side walls 212 of the body frame 210 at the other end of the body frame 210 formed in an overall "H" shape to support the body frame 210 in a cantilever form as a hinge part and rotatably support the body frame 210 about the second rotation axis A2; and a second motion motor 232 installed at one side of the second motion body 231 to rotationally drive the body frame 210.

The second motion body 231 may be installed such that a pair thereof are in contact with both outer side walls 212 of the body frame 210 by a hinged joint at the other end of the body frame 210, and may support the body frame 210 rotatably about the second rotation axis A2 in a cantilever form.

In addition, the second motion module 230 may further include a support cylinder 233 formed to have a variable length so as to support one end of the body frame 210 whose other end is supported in a cantilever form by the second motion body 231 or assist rotational driving force of the body frame 210 by the second motion motor 232, the support cylinder 233 connecting a lower end of the second motion body 231 and the one end of the body frame 210.

For example, the support cylinder 233 may serve as a strut beam supporting one end of the body frame 210, whose other end is supported in a cantilever form by the second motion body 231, so that sagging does not occur downward due to the self-weight of the first motion module 220 and the support stage 100 supported on the upper side thereof, and may serve as an auxiliary drive unit configured to reduce torque load occurring in the second motion motor 232 by distributing and supporting the weight of the one end of the body frame 210 so as to prevent an excessive load from being applied to the second motion motor 232 rotationally driving the body frame 210 in the cantilever form at the other end of the body frame 210.

To this end, a hydraulic cylinder or a pneumatic cylinder that only serves to support a load by hydraulic pressure or pneumatic pressure formed therein without a separate power source may be applied as the support cylinder 233, but an electric cylinder, a hydraulic cylinder, or a pneumatic cylinder configured to serve as load support and power assistance by performing linear motion by itself by a separate power source may of course be applied.

The fourth motion module 250 supports the second motion module 230, and is configured to slidingly move the second motion module 230 along the linear axis A4 perpendicular to the second rotation axis A2.

For example, the fourth motion module 250 may include a fourth motion body 251 formed to extend in a rectangular parallelepiped shape long along the linear axis A4; a plurality of guide rails 252 formed to extend in a rail shape long along the linear axis A4 and installed on an upper side of the fourth motion body 251; a sliding stage 253 installed to be slidingly movable along the plurality of guide rails 252 on the upper side of the fourth motion body 251 and supporting the second motion body 231; and a sliding drive assembly 254 installed at the fourth motion body 251 to slidingly drive the sliding stage 253.

The fourth motion body 251 is formed to extend in a rectangular parallelepiped shape long along the linear axis A4 and may be installed on a floor surface of a manufacturing factory site, and a plurality of wheel members 256 may be installed along a side surface on a width direction (X-axis direction) side so as to facilitate movement at the manufacturing factory site.

The plurality of wheel members 256 may be installed to be movable ascending or descending in an up-down direction (Z-axis direction) by screw coupling rotation, in which a screw rod installed on an upper side is screw-coupled with a nut part installed on a bracket installed on a side surface of the fourth motion body 251 so as to make rolling contact with the floor surface of the manufacturing factory site only when moving the welding positioner apparatus 1000.

In addition, a cover member (see 255 of FIGS. 1 and 2) may be formed on the upper side of the fourth motion body 251 so that the plurality of guide rails 252 and the sliding drive assembly 254 installed on the upper side are not exposed to the outside.

The sliding drive assembly 254 may include a ball screw 254a formed to extend in a rod shape long along the linear axis A4 and rotatably installed on the upper side of the fourth motion body 251 about a central axis parallel to the linear axis A4; a movable nut 254b coupled to a lower side of the sliding stage 253 and screw-coupled to the ball screw 254a so as to be installed to be slidingly movable together with the sliding stage 253 in an extension direction (Y-axis direction) of the ball screw 254a according to rotational driving of the ball screw 254a; and a fourth motion motor 254c installed at one side of the fourth motion body 251 to rotationally drive the ball screw 254a.

Here, the sliding drive assembly 254 exemplifies linear driving by a combination of the ball screw and the movable nut 254b, but is not necessarily limited thereto, and linear driving by various combinations such as a combination of a worm gear and a rack gear configured to convert rotational motion of a motor into linear motion, a combination of a chain and a sprocket, or a combination of a belt and a pulley may be possible, and it may also be possible to apply the drive unit itself as a linear drive unit such as an electric cylinder, a hydraulic cylinder, or a pneumatic cylinder.

Therefore, according to the welding positioner apparatus 1000 according to various embodiments of the present disclosure, the support stage 100 on which the welding object 10 is seated is supported to be automatically rotatable and slidingly movable in at least two or more axes by the multi-axis motion assembly 200, so that even if a welding portion changes during welding of the welding object 10, the changed welding portion can be located within an operation range of a multi-axis automatic welder (not shown) for welding the welding object 10, thereby facilitating a change in a welding posture of the welding object 10 and inducing welding work to be performed uniformly.

Therefore, by automating the welding work of the welding object 10 having a heavy weight such as a cabin of heavy construction equipment by automated multi-axis welding, it is possible to implement the welding positioner apparatus 1000 capable of reducing the possibility of injury to a worker that may occur during the welding posture change of the cabin which is a heavy structure, improving the quality of welding by welding in a constant welding posture, and increasing the efficiency of the cabin manufacturing process of heavy construction equipment.

Although the present disclosure has been described with reference to the embodiments shown in the drawings, this is merely exemplary, and those skilled in the art will understand that various modifications and equivalent other embodiments are possible therefrom. Therefore, the true technical protection scope of the present disclosure should be determined by the technical spirit of the appended claims.

What is claimed is:

1. A welding positioner apparatus comprising:
a support stage configured to seat a welding object thereon;
a multi-axis motion assembly configured to rotatably support the support stage about at least a first rotation axis and a second rotation axis perpendicular to the first rotation axis to enable multi-axis motion control of at least two axes with respect to the support stage;
a clamp module pivotally installed at opposite ends of a seating portion of the support stage to clamp the welding object seated on the support stage, wherein the clamp module is configured to selectively press at least a portion of a lower frame of the welding object; and
a controller configured to control the multi-axis motion of the multi-axis motion assembly such that a welding portion of the welding object is positioned within an operation range of a welder during welding of the welding object.

2. The welding positioner apparatus of claim 1, wherein the multi-axis motion assembly comprises:
a body frame;
a first motion module installed at one end of the body frame to support the support stage and rotate the support stage about the first rotation axis; and
a second motion module installed at the other end of the body frame to support the body frame and rotate the body frame about the second rotation axis.

3. The welding positioner apparatus of claim 2, wherein the first motion module comprises:
a first motion body installed to be in contact with both inner side walls of the body frame so as to be located inside the body frame at the one end of the body frame formed in an overall 'H' shape;
a rotation plate rotatably installed on an upper side of the first motion body about the first rotation axis to support the support stage; and
a first motion motor installed on a lower side of the first motion body to rotationally drive the rotation plate.

4. The welding positioner apparatus of claim 3, wherein the first motion body is installed to be rotatable about a third rotation axis parallel to the second rotation axis at the one end of the body frame.

5. The welding positioner apparatus of claim 4, wherein the multi-axis motion assembly further comprises a third motion module configured to rotationally drive the first motion body by a third motion motor installed to be in contact with an outer side wall of the body frame at the one end of the body frame.

6. The welding positioner apparatus of claim 2, wherein the second motion module comprises:
a second motion body installed to be in contact with both outer side walls of the body frame at the other end of the body frame formed in an overall 'H' shape to support the body frame in a cantilever form as a hinge part and rotatably support the body frame about the second rotation axis; and
a second motion motor installed at one side of the second motion body to rotationally drive the body frame.

7. The welding positioner apparatus of claim 6, wherein the second motion module further comprises a support cylinder formed to have a variable length so as to support the one end of the body frame supported in the cantilever form by the second motion body or assist rotational driving of the body frame by the second motion motor, the support cylinder connecting a lower end of the second motion body and the one end of the body frame.

8. The welding positioner apparatus of claim 2, wherein the multi-axis motion assembly further comprises a fourth motion module configured to slidingly move the second motion module along a linear axis perpendicular to the second rotation axis.

9. The welding positioner apparatus of claim 8, wherein the fourth motion module comprises:
a fourth motion body formed to extend in a rectangular parallelepiped shape long along the linear axis;
a plurality of guide rails formed to extend in a rail shape long along the linear axis and installed on an upper side of the fourth motion body;
a sliding stage installed to be slidingly movable along the plurality of guide rails on the upper side of the fourth motion body and supporting the second motion body; and
a sliding drive assembly installed at the fourth motion body to slidingly drive the sliding stage.

10. The welding positioner apparatus of claim 9, wherein the sliding drive assembly comprises:
a ball screw formed to extend in a rod shape long along the linear axis and rotatably installed on the upper side of the fourth motion body;
a movable nut coupled to a lower side of the sliding stage and screw-coupled to the ball screw, the movable nut installed to be slidingly movable together with the sliding stage in an extension direction of the ball screw according to rotational driving of the ball screw; and
a fourth motion motor installed at one side of the fourth motion body to rotationally drive the ball screw.

11. The welding positioner apparatus of claim 1, wherein the clamp module comprises:
a clamp hinge installed at one end of the seating portion of the support stage;
a clamp body rotatably installed at the clamp hinge to selectively press at least a portion of the lower frame of the welding object during descending rotation;
a rotation cylinder installed on the seating portion of the support stage and formed to have a variable length to rotate the clamp body; and
a two-bar linkage connecting the rotation cylinder and the clamp body so as to convert linear motion of the rotation cylinder into rotational motion of the clamp body.

12. The welding positioner apparatus of claim 1, wherein the support stage comprises:
a stage body formed in an overall rectangular plate shape so that the seating portion on which the welding object is seated is formed; and
a seating guide assembly installed at a support bracket formed to protrude from a corner portion of the stage body, the seating guide assembly configured to guide and support a seating position of the welding object seated on the stage body by a support bushing formed to protrude to an upper side of the support bracket and a support pin formed to protrude to an upper side of the support bushing.
